(19) United States
(12) Patent Application Publication
(10) Pub. No.: US 2007/0144950 A1
(43) Pub. Date: Jun. 28, 2007

(54) Apparatus and method for detecting a built-in filter in photolithography equipment

(76) Inventor: Min-Kyu Choi, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/546,374

(22) Filed: Oct. 12, 2006

(30) Foreign Application Priority Data
Dec. 22, 2005 (KR) 2005-0127591

(51) Int. Cl. B01D 35/14

(52) U.S. Cl. 210/91; 210/94; 210/435

(57) ABSTRACT

A filter detection apparatus for photolithography equipment for fabricating a semiconductor device includes a filter which filters at least one of air bubbles and particles in a photoresist. The apparatus also includes a housing which holds the filter. In addition, the apparatus includes a housing fixing portion which fixes the housing. The apparatus also includes a built-in filter sensing portion which senses a presence of the filter in the housing fixed to the housing fixing portion. The apparatus also includes an indicator which indicates the presence of the filter in the housing, in accordance with a signal sensed in the built-in filter sensing portion.

### BACKGROUND OF THE INVENTION

1. Field of the Invention

The present invention relates generally to semiconductor fabrication and, more particularly, to an apparatus and a method for detecting a built-in filter in photolithography equipment for fabricating a semiconductor device.

This application claims the benefit of Korean Patent Application No. 10-2005-0127591, filed Dec. 22, 2005, the entirety of which is incorporated herein by reference.

2. Description of Related Art

Generally, a semiconductor device is fabricated by repeatedly performing various processes such as, for example, photolithography, etching, vapor deposition, diffusion, and ion implantation, with respect to a wafer. In the photolithography process, photoresist is deposited up to a predetermined thickness on a wafer. Subsequently, a predetermined portion of the photoresist deposited on the wafer is selectively removed or retained by using a mask that includes a predetermined circuit pattern. The removal or retention of the photoresist is performed by exposing the photoresist to light through the mask and developing the photoresist accordingly.

Various types of equipment are used in the photolithography process. For example, processing equipment, such as a spinner, may be used in the photolithography process to dispense photoresist up to a predetermined thickness onto a wafer. To this end, the spinner equipment includes a photoresist supplying apparatus for supplying photoresist to the wafer. The photoresist supplying apparatus includes components such as, for example, a bottle, a pump, a filtering unit, and a dispenser to supply photoresist through the spinner to the wafer.

Photoresist in the bottle of the photoresist supplying apparatus is moved through the bottle by operating the pump. While the pump moves the photoresist in the bottle, the photoresist in the bottle also includes undesirable foreign materials such as, for example, air bubbles and solid particles. These foreign materials are filtered through the filtering unit. The filtered photoresist is then dispensed, in a predetermined amount, by the dispenser onto the surface of a wafer. The wafer receiving the photoresist is typically held in a device such as, for example, a spin coater.

In the photoresist supplying apparatus, the filtering unit includes components that are used to filter the photoresist moving through the bottle. Specifically, the filtering unit includes components such as, for example, a filter, a housing, and a housing fixing portion.

In the filtering unit, the filter is to filter the photoresist. In addition, the housing is used to hold the filter Furthermore, the housing fixing portion is used to hold the housing. Specifically, the housing fixing portion includes a fixing element to firmly connect and fix the housing. The fixing element may be a clamp or a screw that is used to fix the sides of the housing to the housing fixing portion.

However, in a process of connecting the housing with the housing fixing portion, a worker may inadvertently connect and fix the housing to the housing fixing portion without inserting the filter inside the housing. In this case, unfiltered photoresist is dispensed onto the wafer, and as a result, the photoresist deposited on the wafer includes a number of undesirable particles. The presence of undesirable particles in the photoresist deposited on the wafer may cause bad deposition on the wafer.

Furthermore, while unfiltered photoresist flows through a supply line, a number of air bubbles are generated in the unfiltered photoresist. If the air bubbles are allowed to remain in the photoresist unfiltered, the air bubbles may cause the formation of a bad pattern which in turn may cause a decrease in the production yield of the semiconductor fabrication process.

Furthermore, the unfiltered photoresist has an unstable discharging pressure when the unfiltered photoresist is discharged through the dispenser. This unstable discharging pressure may make it difficult to control the amount of photoresist being supplied from the spinner on to the wafer.

The present disclosure is directed towards overcoming one or more problems associated with the conventional photolithography equipment.

### SUMMARY OF THE INVENTION

One aspect of the present disclosure includes a filter detection apparatus for photolithography equipment for fabricating a semiconductor device. The apparatus includes a filter which filters at least one of air bubbles and particles in a photoresist. The apparatus also includes a housing which holds the filter. In addition, the apparatus includes a housing fixing portion which fixes the housing. The apparatus also includes a built-in filter sensing portion which senses a presence of the filter in the housing fixed to the housing fixing portion. The apparatus also includes an indicator which indicates the presence of the filter in the housing, in accordance with a signal sensed in the built-in filter sensing portion.

Another aspect of the present disclosure includes a method for indicating the presence of a filter in photolithography equipment for fabricating a semiconductor device. The method includes providing a filter indicating apparatus including a filter filtering at least one of air bubbles and particles in a photoresist, a housing holding the filter, a housing fixing portion fixing the housing, a built-in filter sensing portion sensing a presence of the filter in the housing fixed to the housing fixing portion, and an indicator indicating the presence of the filter in the housing, in accordance with a signal sensed in the built-in filter sensing portion. The method also includes conducting a built-in filter indicating operation including inserting the filter inside the housing. The method also includes connecting and fixing the housing holding the filter to the housing fixing portion. The method also includes sensing, with the built-in filter sensing portion, whether the filter is built in the housing when the housing is connected to the housing fixing portion. The method also includes indicating, with the indicator, the presence of the filter built in the housing, in accordance with a signal sensed in the built-in filter sensing portion.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a side view illustrating, in a disassembled state, an apparatus which indicates the presence of a built-in filter in photolithography equipment for fabricating a semiconductor device according to an exemplary disclosed embodiment;

FIG. 2 is a side view illustrating, in an assembled state, the apparatus of FIG. 1;

FIG. 3 is a sectional view taken along line A-A of FIG. 1;

FIG. 4 is an enlarged view of a filter that is connected to a housing fixing portion according to an exemplary disclosed embodiment;

FIG. 5 is an enlarged view of a sensor structure of a built-in filter sensing portion according to an exemplary disclosed embodiment;

FIG. 6 is an enlarged sectional view of the sensor structure of the built-in filter sensing portion according to an exemplary disclosed embodiment;

FIG. 7 is a block diagram exemplifying an operation structure of an indicator included in the built-in filter sensing portion having a switch structure according to an exemplary disclosed embodiment; and

FIG. 8 is a flow chart illustrating a method of indicating the presence of a built-in filter according to an exemplary disclosed embodiment.

### DETAILED DESCRIPTION OF EXEMPLARY EMBODIMENTS

The present invention will now be described more fully hereinafter with reference to the accompanying drawings, in which preferred embodiments of the invention are shown. However, the invention should not be construed as limited to only the embodiments set forth herein. Rather, these embodiments are presented as teaching examples.

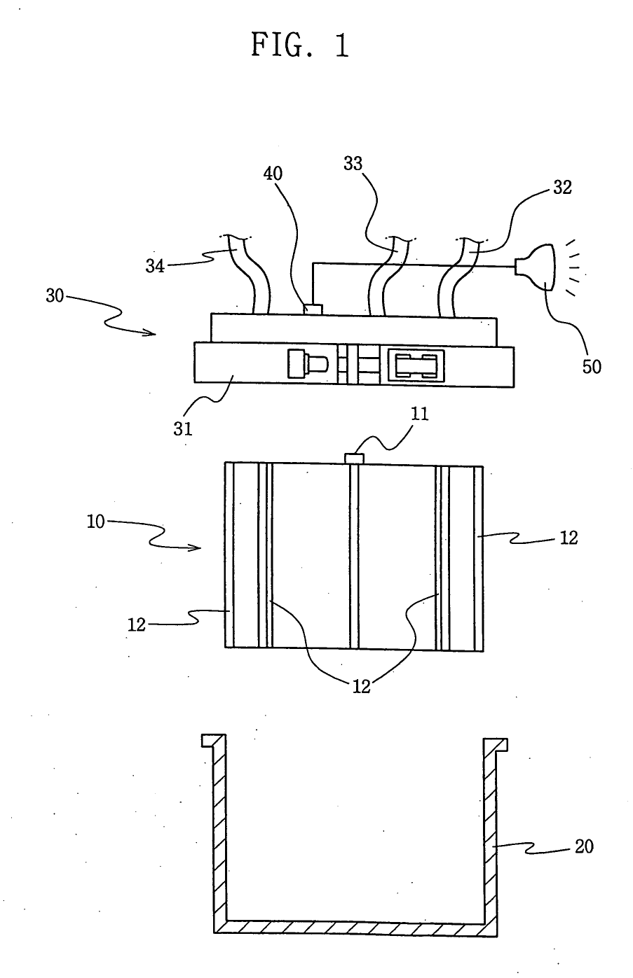

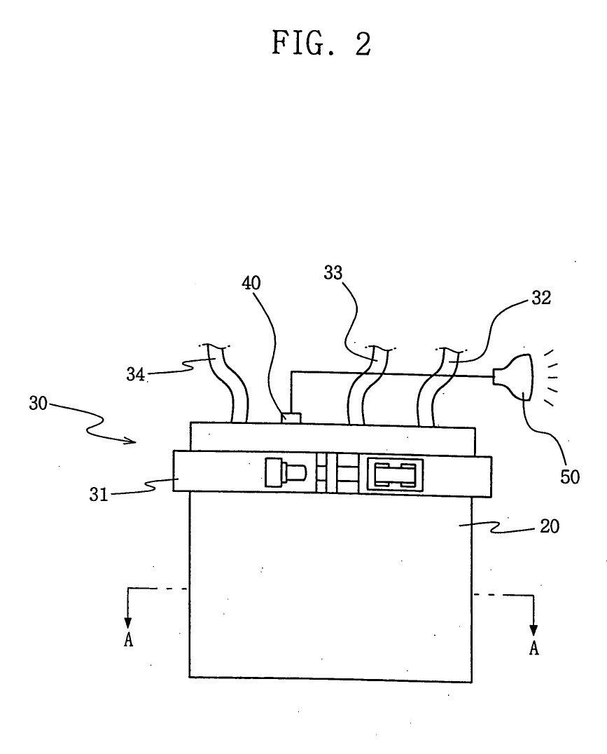

FIG. 1 is a side view illustrating, in a disassembled state, an apparatus which indicates the presence of a built-in filter in photolithography equipment for fabricating a semiconductor device according to an exemplary disclosed embodiment. FIG. 2 is a side view illustrating, in an assembled state, the apparatus of FIG. 1.

In an exemplary embodiment, the apparatus includes a filter 10, an outflow path 11, protruding surfaces 12, a housing 20, a housing fixing portion 30, a fixing element 31, an inlet pipe 32, an outlet pipe 33, a drain pipe 34, a built-in filter sensing portion 40, and an indicator 50. The housing 20 is configured to hold the filter 10. The housing fixing portion 30 fixes the housing 20. The built-in filter sensing portion 40 determines if the filter 10 is built in the housing 20. Specifically, the built-in filter sensing portion 40 makes this determination in accordance with a signal sensed in the built-in filter sensing portion 40. In addition, the indicator 50 sends a signal (that is visible to the naked eye) indicating the presence or absence of the filter 10.

The filter 10 is configured to pass photoresist and filter various foreign materials such as air bubbles and particles or impurities included in the photoresist. The filter 10 may be formed in various shapes. For example, the filter 10 is generally formed in a circular cylindrical or cylindrical shape, or in a polygonal shape. In addition, because the filter 10 is formed vertically in the housing 20, it may have various other shapes based on the direction of the photoresist flow.

Thus, for example, the filter 10 may be formed in the housing 20 such that the photoresist flows in through the middle of one side and flows out through the side surface. Alternatively, the filter 10 may be formed such that the photoresist flows in through the side surface and flows out through the middle of one side.

On the other hand, in an alternative exemplary embodiment, the filter 10 may be built horizontally in the housing 20. In this case, the photoresist flows in through one side surface and flows out through an opposite side surface.

The filter 10, as shown in FIG. 1, has a cylindrical shape. Therefore, in the filter 10, photoresist flows in through the outer circumferential surface of the filter 10 and flows out through the upper portion in the middle portion of the filter 10. Thus, the filter 10 includes the outflow path 11 that is formed in the middle of the filter and has an opening in the upward direction.

The filter 10 is generally received inside the housing 20. While in an alternative exemplary embodiment the filter may be integrally formed with the housing, in the disclosed exemplary embodiment, the filter 10 is structured to be separated from the housing 20. By keeping the filter 10 physically separate from the housing 20, the housing 20 need not be replaced when the filter 10 is replaced. Furthermore, having a physically separate filter 10 may allow for a periodic inspection of the filter 10 rather than having a predetermined replacement schedule irrespective of whether filter 10 actually needs to be replaced.

Thus, the housing 20 includes a space for holding the filter 10 inside and has an open side for inserting and removing the filter 10. In an exemplary embodiment, the upper side of the housing 20 includes an opening so that the filter 10 can be replaced. That is, the filter 10 is inserted in and removed from the housing 20 through the upper side of the housing 20.

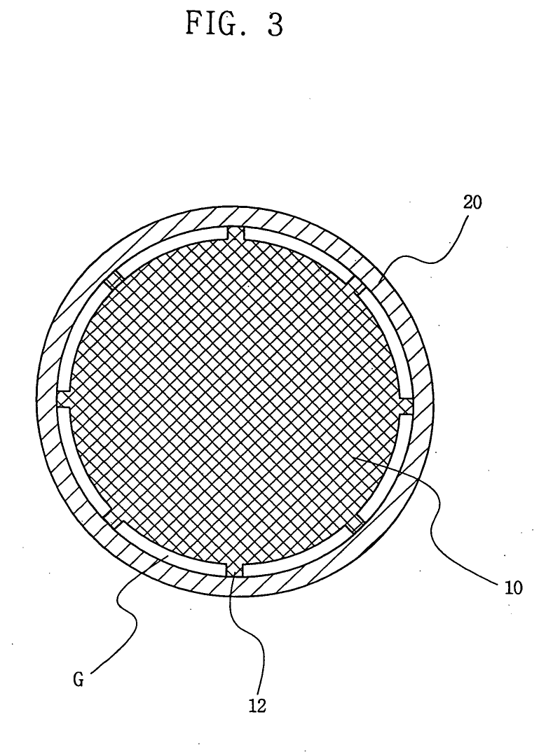

FIG. 3 is a sectional view taken along line A-A of FIG. 2, illustrating the constitution of the filter 10 that is inserted in the housing 20.

It may be preferable that the filter 10 be immovable in the housing 20. However, as shown in FIG. 3, when the photoresist flows in/out through the outer circumferential surface of the filter 10, a gap G may be formed between the surface of the inner diameter of the housing 20 and the surface of the outer diameter of the filter 10.

To form the gap G, the protruding surfaces 12 may be formed on the outer circumferential surface of the filter 10 or the inside diameter surface of the housing 20. Furthermore, the protruding surfaces 12 may be spaced from each other at a predetermined interval along the circumferential surface. In FIG. 3, the protruding surfaces 12 are formed on the outer circumferential surface of the filter 10.

The housing 20 is configured to receive and hold the filter 10. In addition, the housing 20 is connected and firmly fixed to the housing fixing portion 30. Specifically, the housing fixing portion 30 includes the fixing element 31 for fixing the housing 20 to the housing fixing portion 30.

Referring back to FIG. 2, the fixing element 31 may include one or more components which can connect the housing 20 to the housing fixing portion 30. For example, the fixing element 31 may be a male screw and a female screw used in the portion where the housing fixing portion 30 and the housing 20 are connected to each other. Alternatively, the fixing element 31 may be a clamp that clamps the housing 20 to the housing fixing portion 30, as shown in FIGS. 1 and 2. Alternatively, tight sealing may be applied to the connection surface of the housing 20 and the housing fixing portion 30. In addition, any other component that can be used to connect the housing 20 to the housing fixing portion 30 may be used as the fixing element 31.

In an exemplary embodiment, as shown in FIG. 2, the clamp as the fixing element 31 covers and clamps the outer circumference surface of the upper end of the housing 20 to firmly fix the housing 20.

The housing fixing portion 30 may perform other functions besides fixing the housing 20. For example, the housing fixing portion 30 may seal the open side of the housing 20 that is used for inserting and removing the filter 10. Thus, the open side of the housing 20 for inserting and removing the filter 10 is covered when the housing 20 is connected to the housing fixing portion 30. This covering of the housing 20 may prevent the photoresist that flows inside the housing 20 from leaking outside. In addition, the housing fixing portion or the combination of the housing fixing portion and the housing 20 may include the inlet pipe 32 and the outlet pipe 33. Specifically, the photoresist may flow in the housing 20 through the inlet pipe 32 and out of the housing 20 through the outlet pipe 33.

Although both—the inlet pipe 32 and the outlet pipe 33 may be connected to the housing 20, it may be desirable that the housing 20 be easily separable from the housing fixing portion 30. Therefore, as shown in FIG. 2, both, the inlet pipe 32 and the outlet pipe 33 are connected to the housing fixing portion 30. Alternatively, either one of the inlet pipe 32 or the outlet pipe 33 may be connected to the housing 20. In this case, the other pipe may be connected to the housing fixing portion 30.

The apparatus may also include the drain pipe 34. The drain pipe 34 is used to drain unwanted material from the apparatus. For example, the drain pipe 34 may be used for removing the photoresist contained inside the housing 20. In an exemplary embodiment, when the photoresist to be supplied is changed or when the filter 10 is replaced or repaired, the drain pipe 34 is used for discharging the photoresist contained in the housing 20 to the external surrounding. The drainage of the photoresist using the drainage pipe 34 will ensure that the photoresist is removed from the housing 20. To this end, the drain pipe 34 may be connected to the filtering portion as well as the inlet pipe 32 and the outlet pipe 33.

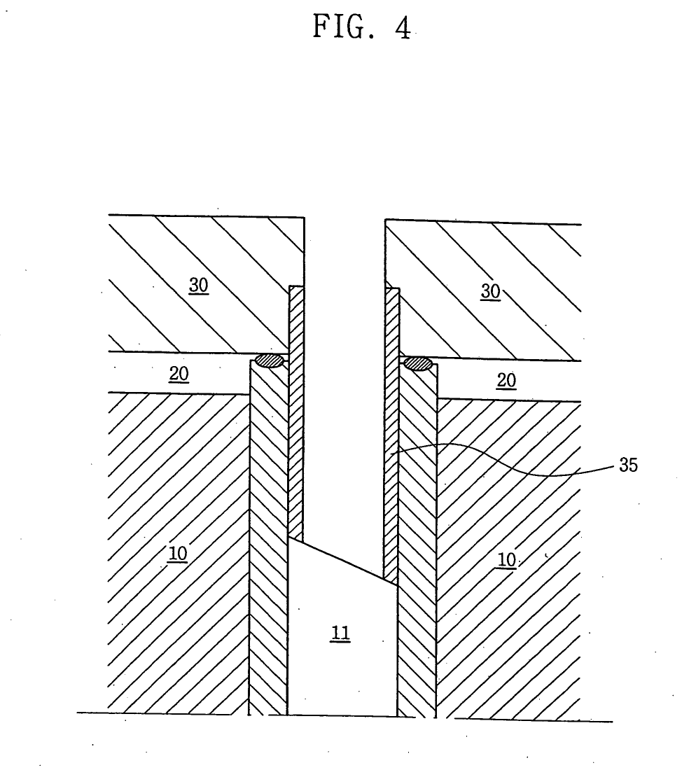

FIG. 4 is an enlarged view illustrating the apparatus when the filter 10 is connected to the housing 20, according to an exemplary disclosed embodiment. As shown in FIG. 4, a flow-out path 11 is formed in the middle portion of the filter 10. In addition, the housing fixing portion 30 may include a cylindrical tube 35, so that the flow-out path 11 formed on the top in the middle portion of the filter 10 can be smoothly connected to the outlet pipe 33 when the housing 20 is connected to the housing fixing portion 30.

In addition, when the housing 20 is connected to the housing fixing portion 30, the filter 10 inserted inside the housing 20 is fitted with the tube 35 protruding downward from the middle portion of the housing fixing portion 30 to the bottom of the housing fixing portion 30. The tube 35 may be configured such that the outlet pipe 33 and the flow-out path 11 are connected with each other. To this end, the tube 35 connects the outlet pipe 33 and the flow-out path 11 through the housing fixing portion 30. Thus, a part of the tube 35 of the housing fixing portion 30 is inserted into the flow-out path 11 of the filter 10, so that the photoresist guided through the flow-out path 11 flows through the outlet pipe 33.

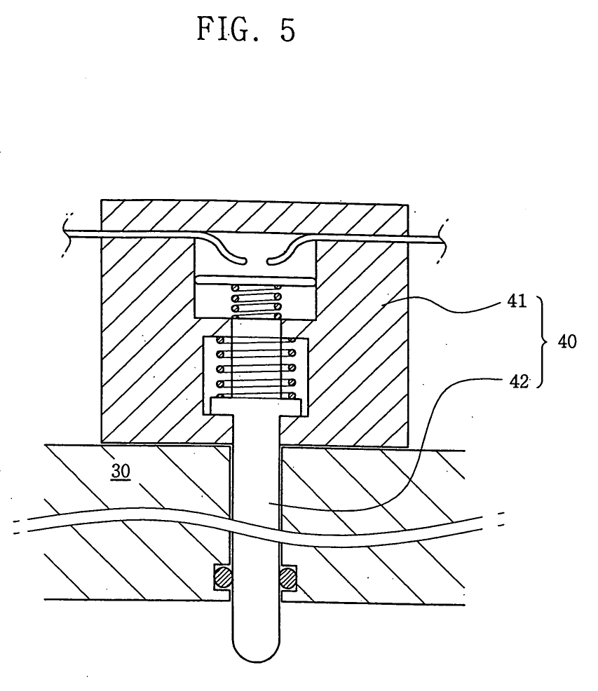

As mentioned above, the photoresist supplying apparatus includes a sensor which detects whether a filter is present in the housing 20 or not. FIG. 5 illustrates a built-in filter sensing portion 40 according to an exemplary disclosed embodiment. The built-in filter sensing portion 40 senses whether the filter 10 is built in the housing 20 when the housing 20 is connected to the housing fixing portion 30.

Based on the type of sensor used, the built-in filter sensing portion 40 may configured in a switch structure or a sensor structure. As shown in FIG. 5, the built-in filter sensing portion is configured as a switch. Furthermore, the built-in filter sensing portion 40 is positioned on the housing fixing portion 30. In addition, the built-in filter sensing portion includes a body 41 and a plunger 42. The body 41 is connected to a portion of the upper side of the housing fixing portion 30. The plunger 42 vertically penetrates through the housing fixing portion 30.

The body 41 of the built-in filter sensing portion 40 includes a switch structure (not shown). The switch structure may include, for example, a switching terminal. The switch structure is powered ON/OFF based on a minute up/down movement of the plunger 42.

The upper end of the plunger 42 is inserted in the body 41. This insertion into the body 41 may support the plunger 42 so as to prevent the plunger from breaking away from the body 41. The lower end of the plunger 42 protrudes downward from the bottom of the housing fixing portion 30. Furthermore, the plunger 42 is sealed with the housing fixing portion 30 by an O-ring.

As shown in FIG. 5, the bottom of the housing fixing portion 30 includes a hole which is formed vertically and guides the up and down movement of the plunger 42. In addition, the bottom of the housing fixing portion 30 is filled with photoresist when the housing 20 with the filter 10 is connected to the housing fixing portion 30. Thus, the bottom of the housing fixing portion 30 prevents the photoresist from flowing out through the hole.

When the housing 20 is connected to the housing fixing portion 30, the up and down movement of the plunger 42 turns ON/OFF the switching terminal in the body 41, depending on whether the filter 10 is built in the housing 20.

For example, when the housing 20 with the filter 10 is connected to the housing fixing portion 30, the filter 10 presses the lower end of the plunger 42 and the plunger 42 moves upwards. At this time, the switching terminal in the body 41 is ON due to the upward movement of the plunger 42.

On the other hand, in the built-in filter sensing portion 40 having the switch structure, if the filter 10 is not built in the housing fixing portion 30 or when the housing 20 is separated from the housing fixing portion 30, the switching terminal in the body 41 is turned OFF by the downward movement of the plunger 42.

In another exemplary embodiment, the switching operation may be performed vice versa. That is, the switching terminal in the body 41 may be turned ON by the downward movement of the plunger 42 and may be turned OFF by the upward movement of the plunger 42.

The aforementioned switch structure is illustrated as an exemplary embodiment only. One skilled in the art will appreciate that the built-in filter sensing portion 40 may have different configurations besides the switch structure. For example, the built-in filter sensing portion 40 may be formed in a sensor structure instead of the switch structure.

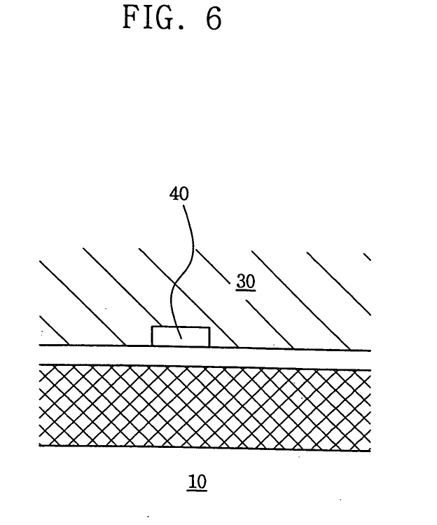

FIG. 6 is an enlarged sectional view illustrating the sensor structure of the built-in filter sensing portion according to an exemplary disclosed embodiment.

The built-in filter sensing portion 40 having the sensor structure is directly attached to one side of the bottom of the housing fixing portion 30. Specifically, as shown in the drawing, the built-in filter sensing portion 40 having the sensor structure may be inserted in the housing fixing portion 30 or may be attached to the bottom of the housing fixing portion 30 and minutely protrude from the bottom of the housing fixing portion 30.

Furthermore, the built-in filter sensing portion 40 uses a sensor to directly sense whether the filter 10 is built inside the housing 20. For the purpose of sensing the filter 10, the built-in filter sensing portion 40 may use a photo sensor or a proximity sensor.

The signal sensed in the built-in filter sensing portion 40 having the sensor structure is transferred to an equipment controller (not shown in FIG. 6). The controller is configured to indicate whether the filter 10 is built inside the housing based on the signal received from the built-in filter sensing portion 40.

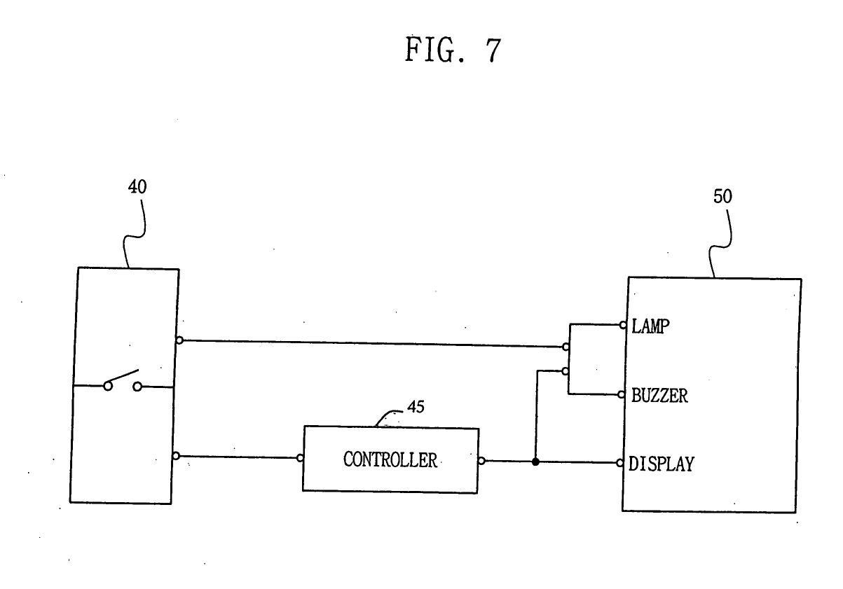

FIG. 7 is a block diagram exemplifying the operation of an indicator 50 through the built-in filter sensing portion 40 that has a switch structure according to an exemplary disclosed embodiment. Generally, the indicator 50 uses a bell or a buzzer for sound, a lamp for light, and a display for characters and symbols, thereby indicating whether the filter 10 is built in the housing 20

As shown in FIG. 7, in the case of the built-in filter sensing portion 40 having the switch structure, the built-in filter sensing portion 40 directly switches ON if the filter 10 is built in the housing 20 and operates the indicator 50. Alternatively, after the switching signal of the built-in filter sensing portion 40 is perceived in a controller 45, the indicator 50 may operate using a lamp, buzzer, or display.

The lamp or buzzer may be directly operated by the switching operation of the built-in filter sensing portion 40 having the switch structure. However, the display representing characters or symbols is operated only through the controller.

Furthermore, in the built-in filter sensing portion 40 having the sensor structure, the built-in filter sensing portion 40 applies the sensed signal to the controller as described above. Then, the lamp, buzzer, or display is operated by the signal from the controller, thereby indicating whether the filter 10 is built inside the housing 20 or not.

Specifically, the indicator 50 is positioned to be adjacent to the filtering portion, thereby making it possible to immediately and easily check whether the filter 10 is built inside the housing 20 at the time the housing 20 is fixed to the housing fixing portion 30.

A method of indicating the presence of the built-in filter in the equipment using the photoresist supplying apparatus discussed above will now be described in accordance with an exemplary disclosed embodiment.

In the photoresist supplying apparatus of spinner equipment, the filter 10 is replaced or separated from the housing when the equipment is re-operated after the operation of the equipment is stopped. The operations of the equipment may be stopped for reasons such as regular or irregular check and repair. In addition, the filter 10 is replaced with a new filter when the time of use of the filter 10 expires or when the photoresist to be supplied is replaced.

As discussed above, when the filter 10 needs to be replaced and the housing 20 receiving the filter 10 is fixedly connected to the housing fixing portion 30, it is difficult to accurately check, from the outside, whether the filter 10 is inserted in the housing 20. Thus, when the housing 20 is separated from the housing fixing portion 30 in order to replace the filter 10 with a new one, the housing 20 without the filter 10 may be inadvertently connected to the housing fixing portion 30.

In an exemplary embodiment, when the housing 20 is connected to the housing fixing portion 30, the built-in filter sensing portion 40 senses whether the filter 10 is built inside the housing 20 and the indicator 50 sends an audio and/or visual signal indicating the presence or absence of the filter 10.

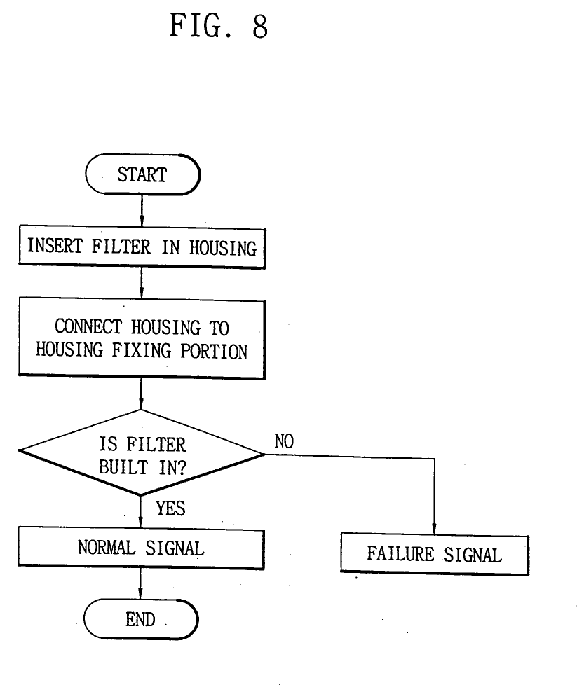

FIG. 8 is a flow chart illustrating a method of indicating the presence of the built-in filter according to an exemplary disclosed embodiment.

To replace the filter 10 with a new filter in the filtering portion of the photoresist supplying apparatus, the housing 20 receiving the filter 10 should be separated from the housing fixing portion 30. When the housing 20 is separated from the housing fixing portion 30, the filter 10 inserted inside the housing 20 is also separated from the housing fixing portion 30. At this time, the indicator 50 sends a signal indicating that the filter 10 is not built in the housing 20.

If the indicator 50 accurately changes its signal from showing the presence of the filter 10 to showing the absence of the filter 10 when the housing 20 is separated from the housing fixing portion 30, then it is verified that the indicator 50 is operating satisfactorily. However, when the housing 20 with the filter 10 is separated from the housing fixing portion 30, if the indicator 50 continues to indicate the presence of the filter 10, the built-in filter sensing portion 40 and the indicator 50 are not functioning properly. In this case, it may be necessary to check or repair the built-in filter sensing portion 40 and the indicator 50.

Under normal operating conditions, when the housing 20 is separated from the housing fixing portion 30, the indicator 50 sends a signal indicating the absence of the filter 10. When the housing 20 is separated from the housing fixing portion 30, the filter 10 is exposed to various minute contaminants from the outside. Therefore, the filter 10, which had been inserted in the housing 20, is removed from the housing 20 and is replaced by inserting a new filter 10 in the housing 20.

After the new filter 10 is inserted inside the housing 20 separated from the housing fixing portion 30, the housing 20 is connected and fixed to the housing fixing portion 30. This fixing of the housing 20 to the housing fixing portion 30 prevents the housing 20 from breaking away from the housing fixing portion 30. In an exemplary embodiment, the fixing element 31 is used to fix the housing portion 20 to the housing fixing portion 30.

When the housing 20 is fixed to the housing fixing portion 30 by the fixing element 31, the built-in filter sensing portion 40 comes into contact with the top surface of the filter 10 inserted inside the housing 20. Alternatively, the built-in filter sensing portion 40 senses the filter 10. When the built-in filter sensing portion 40 senses the presence of the filter 10, the indicator 50 displays a predetermined indication thereof.

However, when the housing 20 is connected and fixed to the housing fixing portion 30 by the fixing element 31, if the built-in filter sensing portion 40 senses the absence of the built-in filter 10, the indicator 50 indicates the absence of the built-in filter 10. At this time, it may be necessary to directly check whether the filter 10 is built in the housing 20 by again separating the housing 20 from the housing fixing portion 30. When it is determined that the filter 10 is not built in the housing 20, the filter 10 should be accurately inserted in the housing 20 and the housing 20 be again connected and fixed to the housing fixing portion 30.

If the indicator 50 indicates the absence of the filter 10 although the filter 10 is normally built in the housing 20, this indicates a failure or error of the built-in filter sensing portion 40 and indicator 50. The built-in filter sensing portion 40 and the indicator 50 should therefore be examined at this time.

The disclosed filter checking apparatus and method can be used in any system configured to deposit photoresist on a wafer. By accurately determining the presence/absence of the filter 10 by using the built-in filter sensing portion 40 and the indicator 50, the processing performance of the photoresist supplying apparatus may be improved.

In addition, as described above, when the filter 10 is accurately built in the housing 20, it is possible to filter foreign materials such as air bubbles or minute particles existing in the photoresist, thereby supplying pure photoresist to the wafer. Furthermore, when the filter 10 is stably built in the housing 20, it is possible to accurately control the amount of the photoresist to be dispensed onto the wafer by the pump. That is, when a pressure of supplying the photoresist is stably maintained, a photoresist layer coating on the wafer can be evenly deposited, thereby improving a processing efficiency.

In addition, the disclosed photoresist supplying apparatus may include a transparent housing 20 for receiving the filter 10. A transparent housing 20 may increase the production yield of the photoresist supplying apparatus. For example, when an engineer fits the filter 10 in the housing 20 or when the photoresist is being deposited on the wafer, an engineer may need to check whether the filter 10 is accurately inserted in the housing 20. However, it may be impossible to check the presence of the built-in filter 10 while the photoresist is being deposited on the wafer. Therefore, the engineer may have to wait until the operation of the photoresist supplying apparatus has ceased.

However, when the engineer doubts if the filter 10 is built in the housing 20, a problem may have already affected a processing yield. Thus, if the engineer is unable to check the presence of the filter 10 immediately, the production yield of the process may be adversely affected.

In an exemplary embodiment, because the housing 20 is transparent, the presence or absence of the built-in filter 10 is directly visible to the engineer at all times. Therefore, the engineer may not have to separate the housing 20 from the housing fixing portion 30 to determine the presence or absence of the filter 10. In addition, the transparent housing 20 may permit the engineer to check on the supply of photoresist from the housing 20 at all times.

As described above, when the housing 20 is connected to the housing fixing portion 30, the presence or absence of the filter 10 inside the housing 20 can be easily and accurately checked by the indicator 50. Therefore, it is possible to prevent, in advance, any process from being performed when the filter 10 is not present in the housing 20.

Furthermore, as described above, the photoresist is supplied from the photoresist supplying apparatus only after the filter 10 is accurately built in the housing 20 and a pressure of supplying the photoresist is stably controlled. Thus, the filtered photoresist is of a good quality and can be accurately and safely supplied to the wafer, thereby improving a processing yield and a production yield of the semiconductor fabrication process.

Furthermore, in accordance with an exemplary embodiment, the transparent housing 20 is used so as to enable an operator to visually determine the presence or absence of the filter 10 in the housing 20. Thus, no additional check for the presence of the filter 10 is required.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A filter detection apparatus for photolithography equipment for fabricating a semiconductor device, the apparatus comprising:
a filter which filters at least one of air bubbles and particles in a photoresist;
a housing which holds the filter;
a housing fixing portion which fixes the housing;
a built-in filter sensing portion which senses a presence of the filter in the housing fixed to the housing fixing portion; and
an indicator which indicates the presence of the filter in the housing, in accordance with a signal sensed in the built-in filter sensing portion.

2. The apparatus according to claim 1, wherein the filter comprises a plurality of protruding surfaces formed on an outer circumferential surface of the filter and spaced from each other, at a predetermined interval, along the outer circumferential surface.

3. The apparatus according to claim 1, wherein the filter comprises a flow-out path formed in a middle portion of the filter and opened upwardly, with a predetermined diameter.

4. The apparatus according to claim 1, wherein the housing comprises an open side to insert and remove the filter.

5. The apparatus according to claim 4, wherein the housing fixing portion covers the open side of the housing.

6. The apparatus according to claim 1, wherein the housing fixing portion comprises a fixing element which fixes the housing.

7. The apparatus according to claim 6, wherein the fixing element is a clamp covering and clamping an outer circumferential surface of an upper end of the housing.

8. The apparatus according to claim 3, wherein the housing fixing portion comprises a cylindrical tube formed in a middle portion of a bottom of the housing fixing portion, the cylindrical tube protruding downwards at a predetermined height such that a part of a lower end of the housing fixing portion is inserted in the flow-out path.

9. The apparatus according to claim 1, wherein the built-in filter sensing portion comprises:
a body, the body connected to a portion of an upper side of the housing fixing portion, and including a switching structure; and
a plunger including an upper end configured to be movably inserted inside the body, wherein the plunger penetrates the housing fixing portion, extends to protrude downward from a bottom of the housing fixing portion, and controls operation of the switching structure by a vertical movement, based on the presence or absence of the filter in the housing connected to the housing fixing portion.

10. The apparatus according to claim 1, wherein the built-in filter sensing portion comprises a photo sensor attached to a side of a bottom of the housing fixing portion.

11. The apparatus according to claim 1, wherein the built-in filter sensing portion comprises a proximity sensor attached to a side of a bottom of the housing fixing portion.

12. The apparatus according to claim 10, wherein the built-in filter sensing portion transfers a sensed signal to an equipment controller such that the sensed signal is checked.

13. The apparatus according to claim 11, wherein the built-in filter sensing portion transfers a sensed signal to an equipment controller such that the sensed signal is checked.

14. The apparatus according to claim 1, wherein the indicator operates as a bell or buzzer.

15. The apparatus according to claim 1, wherein the indicator operates as a lamp.

16. The apparatus according to claim 1, wherein the indicator displays characters or symbols.

17. A method for indicating the presence of a filter in photolithography equipment for fabricating a semiconductor device, the method comprising:
providing a filter indicating apparatus including a filter filtering at least one of air bubbles and particles in a photoresist, a housing holding the filter, a housing fixing portion fixing the housing, a built-in filter sensing portion sensing a presence of the filter in the housing fixed to the housing fixing portion, and an indicator indicating the presence of the filter in the housing, in accordance with a signal sensed in the built-in filter sensing portion; and
conducting a built-in filter indicating operation comprising:
inserting the filter inside the housing;
connecting and fixing the housing holding the filter to the housing fixing portion;
sensing, with the built-in filter sensing portion, whether the filter is built in the housing when the housing is connected to the housing fixing portion; and
indicating, with the indicator, the presence of the filter built in the housing, in accordance with a signal sensed in the built-in filter sensing portion.

18. An apparatus for indicating the presence of a filter in photolithography equipment for fabricating a semiconductor device, the apparatus comprising:
a filter which filters at least one of air bubbles and particles in a photo resist;
a housing which holds the filter; and
a housing fixing portion which fixes the housing, wherein the housing is made of a transparent material to check the presence of the filter by a visual inspection.
